(19) United States
(12) Patent Application Publication
(10) Pub. No.: US 2005/0154697 A1
(43) Pub. Date: Jul. 14, 2005

(54) Adjusting a number of database replicas based on a defined threshold value

(75) Inventors: Faheem Altaf, Austin, TX (US); Kumar Ravi, Cedar Park, TX (US); Michael J. Reynolds, Austin, TX (US)

Correspondence Address: Intellectual Property Law Dept.;IBM Corporation, 11400 Burnet Road, Austin, TX, 78758, US

(73) Assignee: International Business Machines Corporation, Armonk, NY (US)

(21) Appl. No.: 10/756,874

(22) Filed: Jan. 14, 2004

(51) Int. Cl. G06F 7/00

(52) U.S. Cl. 707/1

(57) ABSTRACT

A method and apparatus is provided for adjusting a number of database replicas of a database based on a defined threshold value. The method comprises monitoring at least one operating condition associated with a database and accessing a prestored threshold value. The method further comprises comparing a value representative of the monitored operating condition with the prestored threshold value and adjusting a number of copies of at least a portion of the database based on the comparison.

### BACKGROUND OF THE INVENTION

1. Field of the Invention

The invention generally relates to databases, and, in particular, to adjusting a number of database replicas that are accessible based on a defined threshold value.

2. Description of the Related Art

Large and small companies alike are relying more and more on networked computing to expand their competitive edge beyond their customary borders. As computing networks and networked applications become more prevalent, features like “high availability” become desirable. The term “high availability” commonly refers to having substantially continuous and uninterrupted access to networked resources.

A number of different prior art techniques have been proposed to achieve continuous data access. These initial techniques introduced the concept of synchronized data redundancy, and were primarily implemented at the operating system level. With advancements in technology, developers started implementing the “high availability” feature in networked applications as well. In networked computing systems, high availability can be achieved through synchronized redundancy of selected system components by “clustering them.” A “cluster” is a collection of hardware or software components that clients on the network access as a single, virtual resource that is highly available. Individual cluster components can be physically located in the same room or dispersed around the world and connected by a network.

With clusters, selected network elements can be duplicated to provide substantially continuous and reliable access. For example, a database may be replicated on a plurality of servers by an administrator to improve user access to the database. Database replication in a clustered environment (or even in other environments), however, is a manual and time-consuming process. That is, an administrator must frequently monitor which databases require replication, determine a desirable location to create a database replica, and then create the database replica at the desired location. Furthermore, the administrator generally has to track the various database replicas on the network and to remove any unneeded database replicas if the database is being underutilized, for example. Over time, managing these databases can become labor intensive and time consuming for the administrator, particularly as the number of databases within a cluster grows.

The present invention is directed to addressing, or at least reducing, the effects of, one or more of the problems set forth above.

### SUMMARY OF THE INVENTION

In one aspect of the instant invention, a method is provided for adjusting a number of database replicas based on a defined threshold value. The method comprises monitoring at least one operating condition associated with a database and accessing a prestored threshold value. The method further comprises comparing a value representative of the monitored operating condition with the prestored threshold value and adjusting a number of copies of at least a portion of the database based on the comparison.

In another aspect of the instant invention, an apparatus is provided for adjusting a number of database replicas based on a defined threshold value. The apparatus comprises a storage unit having stored therein a database, the storage unit being communicatively coupled to a control unit. The control unit is adapted to determine at least one operating condition associated with the database and access a prestored threshold value. The control unit is further adapted to compare a value representative of the determined operating condition with the prestored threshold value and adjust a number of database replicas based on the comparison.

In yet another aspect of the instant invention, an article comprising one or more machine-readable storage media containing instructions is provided for adjusting a number of database replicas based on a defined threshold value. The instructions, when executed, enable a processor to determine at least one operating condition associated with a database and access a prestored threshold value. The instructions, when executed, further enable the processor to compare a value representative of the determined operating condition with the prestored threshold value and adjust a number of database replicas based on the comparison.

In yet another aspect of the instant invention, a system is provided for adjusting a number of database replicas based on a defined threshold value. The system comprises a first server communicatively coupled to a second server. The second server is adapted to determine at least one operating condition associated with a database and access a prestored threshold value. The second server is further adapted to compare a value representative of the determined operating condition with the prestored threshold value and cause a database replica to be created on the first server based on the comparison.

In another aspect of the instant invention, a method is provided for adjusting a number of database replicas based on a defined threshold value. The method comprises monitoring at least one of a user load level and network traffic level associated with accessing of a database and accessing a preselected threshold value. The method further comprises comparing at least one of the user load level and network traffic level with the preselected threshold value and automatically adjusting a number of copies of at least a portion of the database based on the comparison.

### BRIEF DESCRIPTION OF THE DRAWINGS

The invention may be understood by reference to the following description taken in conjunction with the accompanying drawings, in which like reference numerals identify like elements.

FIG. 1 is a block diagram of an embodiment of a communications system including a module for database management, in accordance with the present invention.

FIG. 2 depicts a flow diagram of one aspect of the module of FIG. 1, in accordance with one embodiment of the present invention.

FIG. 3 illustrates a flow diagram of an alternative aspect of the module of FIG. 1, in accordance with one embodiment of the present invention.

FIG. 4 depicts a block diagram of a processor-based system that may be implemented in the communications system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

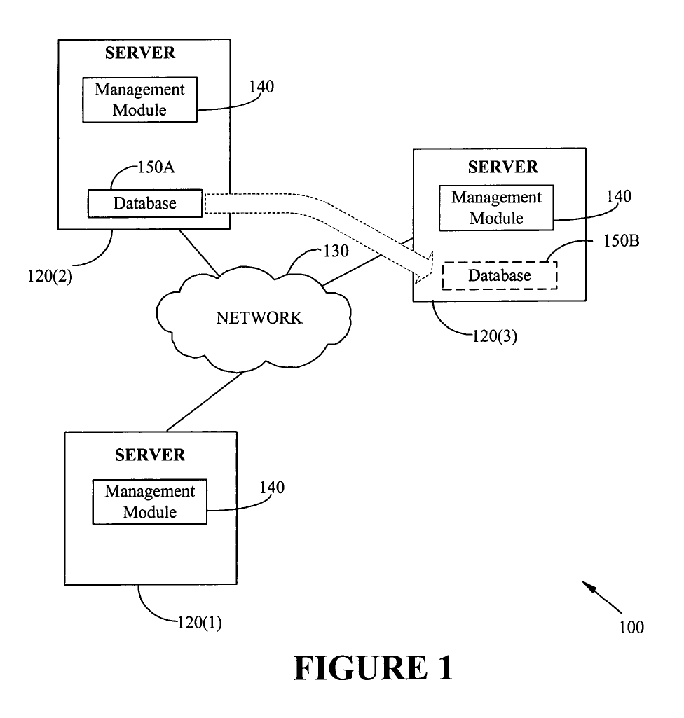

Referring to FIG. 1, a communications system 100 is illustrated in accordance with one embodiment of the present invention. The communications system 100 includes a plurality of servers 120(1-3) that may be communicatively coupled by a network 130, such as by a private network or a public network (e.g., the Internet). The servers 120(1-3) may be any variety of processor-based devices, and may include computers (e.g., desktops, laptops, mainframes), portable electronic devices, Internet appliances, and the like. In one embodiment, the various devices 120(1-3) may be coupled to the network 130 through a router (not shown), gateway (not shown), or by other intervening, suitable devices.

Although not so limited, in the illustrated embodiment the servers 120(1-3) are part of a cluster, such as a Domino cluster. The servers 120(1-3) may each include a management module 140 that, as described in greater detail below, manages the number of database replicas 150B of databases 150A in the cluster based on user-defined threshold values. For example, the management module 140 may monitor the usage of the database 150A, and if it is determined that a relatively large number of users are accessing the database 150A at a given time (or over a selected time period), the management module 140 may create one or more database replicas 150B of the database 150A on one or more suitable servers 120(1-3) to better respond to the user demand. In the illustrated embodiment of FIG. 1, the management module 140, for example, creates a database replica 150B on the server 120(3). In one embodiment, the management module 140 may track the number of database replicas 150B of a given database 150A in the cluster, and based on certain factor(s) or parameter(s) (collectively hereinafter referred to as “condition(s)”), adjusts (e.g., increases or reduces) the number of database replicas 150B of the database 150A. By adjusting the number of database replicas 150B based on certain condition(s), the management module 140, in one embodiment, is able to provide database replicas 150B on an as-needed basis. The management module 140, in one embodiment, may manage the replication and deletion of databases 150A in a manner that is transparent to the users and to the administrator. As such, the management module 140 may reduce at least some of the administrator's burden of managing databases in the cluster or system 100. Various embodiments of the present invention are described in greater detail below.

It should be appreciated that while a single management module 140 is depicted in FIG. 1, that in alternative embodiments, the management module 140 may comprise a plurality of modules, with each module capable of providing one or more of the desired features. For example, the management module 140 may include a module for maintaining a cluster database directory that contains information about the various databases and their database replicas 150B within the cluster. This information may be used by the cluster to determine fail-over paths and to control access to a database 150A. As another example, the management module 140 may include a module for maintaining a substantially up-to-date list of the servers 120(1-3) in the cluster. This module may maintain a list of servers 120(1-3) that are currently available in the cluster and the information about active workloads for each server 120. The management module 140 illustrated in FIG. 1 is implemented in software, although in other implementations it may also be implemented in hardware or a combination of hardware and software.

The network 130 of FIG. 1 may be a packet-switched data network, such as a data network according to the Internet Protocol (IP). Examples of the network 130 may include local area networks (LANs), wide area networks (WANs), intranets, and the Internet. One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 130 may also include other types of packet-based data networks in further embodiments. Examples of such other packet-based data networks include Asynchronous Transfer Mode (ATM), Frame Relay networks and the like.

As utilized herein, a “network” may refer to one or more communication networks, channels, links, or paths, and systems or devices (such as routers) used to route data over such networks, channels, links, or paths. Furthermore, the term “database” may refer to any file capable of being stored in a storage unit, regardless of the content of the file or the format in which the content is stored in the file. In one embodiment, the term “database” may refer to a repository file in which information is organized in a manner that can be readily accessed by other applications.

It should be understood that the configuration of the communications system 100 of FIG. 1 is exemplary in nature, and that fewer, additional, or different components may be employed in other embodiments of the communications system 100. For example, while the communications system 100 in the illustrated example includes three servers 120(1-3), in other embodiments, the number of servers 120 employed may be more or fewer. Moreover, it should be appreciated that any desirable number of databases 150A may be created, stored, and replicated in the communications system of FIG. 1. In one embodiment, the management module 140 may be located in a centralized location that can be accessed by the various servers 120(1-3) in the cluster. In an alternative embodiment, various portions of the management module 140 may be distributed across the various servers 120(1-3), where each portion may perform a desired feature. In such an embodiment, if desired, any of the servers 120(1-3) may access the portion of the management module 140 that resides on any of the other servers 120(1-3) in the cluster. Similarly, other configurations may be made to the communications system 100 without deviating from the spirit and scope of the invention.

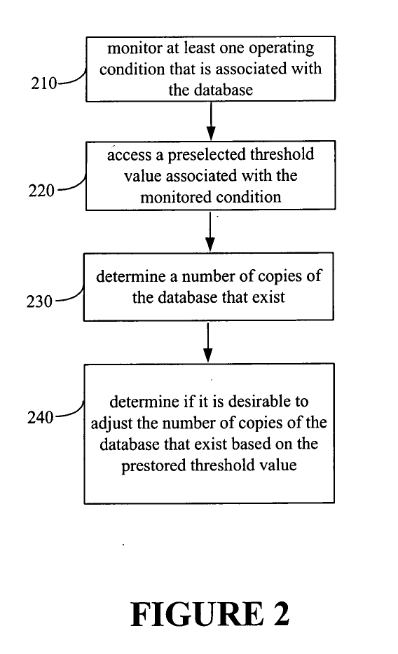

FIG. 2 illustrates a flow diagram illustrating at least one operation performed by the management module 140 of FIG. 1 to manage the number of copies of the database 150A that are present in the cluster or the communications system 100, in accordance with one embodiment of the present invention. For ease of illustration, it is herein assumed that the communications system 100 of FIG. 1 initially contains a single database 150A stored on the server 120(2).

Referring to FIG. 2, the management module 140 monitors (at 210) at least one operating condition that may affect access to the database 150A. A variety of operating conditions can affect, either directly or indirectly, a user's ability to access the database 150A, and any one or more of these operating conditions may be monitored (at 210) by the management module 140. For example, the management module 140 may monitor (at 210) the number of users that access the database 150A over a given time period. The number of users accessing the database 150A at any given time (e.g., the user load) can affect access to the database 150A. That is, users may naturally experience a slower response time when a large number of users are accessing a database 150A in comparison to when a small number of users are accessing the database 150A. The act of monitoring need not be continuous; the management module 140 may monitor the operating condition periodically or at selected times on an as-needed basis.

As another example, the management module 140 may monitor (at 210) the amount of traffic on the network 130 that the users utilize to access the database 150A. A relatively heavy network traffic, for instance, can impair a user's ability to access the database 150A. As yet another example, the management module 140 may monitor (at 210) the processing load (processor utilization) of the server 120(2). An under-utilized server 120 may be in a better position to respond to database queries, as opposed to an over-utilized server 120. Thus, the processing load of the server 120(2) may affect access to the database 150A. As another example, the management module 140 may monitor (at 210) availability of hardware resources of the server 120(2), such as available storage space, memory, and the like. In another example, the management module 140 may monitor (at 210) the frequency of failovers that have occurred in association with access to the database 150A. A relatively high failover rate associated with the database 150A may, for example, indicate that the database 150A itself is corrupted, or may indicate some other defect associated with accessing the database 150A. As such, it may be desirable to create one or more database replicas 150B of the database 150A to improve access to the database 150A.

The above-presented list of operating conditions that can be monitored by the management module 140 is exemplary in nature, and thus the list is not intended to be exhaustive. Those skilled in the art having the benefit of this disclosure will appreciate that in addition to the above noted operating conditions, there may be other types of operating conditions that may also affect access to the database 150A. Thus, the management module 140 may monitor (at 210) other types of operating conditions as well without deviating from the spirit and scope of the present invention.

The management module 140 accesses (at 220) a preselected threshold value associated with the monitored condition. As explained below, based on the threshold value, the management module 140 may determine that additional or fewer copies of the database 150A in the cluster are desired. The threshold value, in one embodiment, may be a pre-stored or pre-defined user value, and can be adjusted dynamically, if desired. In an alternative embodiment, the threshold value may be derived by the management module 140 based on the surrounding conditions (i.e., self learnt). Depending on the nature of the condition that is monitored (at 210), the threshold value may be representative of user load over a selected time period (e.g., 80 users/day), server load (e.g., 25% of the resources being utilized), frequency of failovers (e.g., 1 failover every hour), resource availability of the server 120 (e.g., disk space 90% full), and the like.

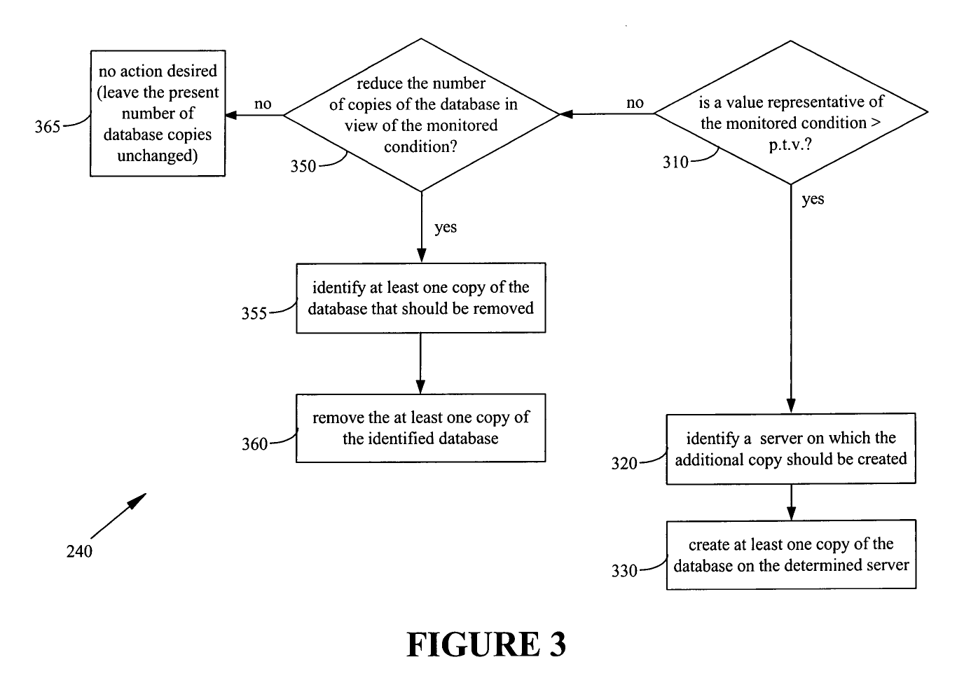

The management module 140 determines (at 230) the number of database replicas 150B of the database 150A that exist in the cluster. For example, in the illustrated embodiment of FIG. 1, only one database replica 150B of the database 150A exists. The management module 140 determines (at 240) if it is desirable to adjust the number of database replicas 150B of the database 150A that were determined (at 230) based on the preselected threshold value associated with the monitored condition. Based on the threshold value, the management module 140 may increase the number of existing database replicas 150B, may decrease the number of database replicas 150B, or may leave the number of existing database replicas 150B unchanged, as explained in FIG. 3.

FIG. 3 illustrates one embodiment of a flow diagram of block 240 of FIG. 2 in accordance with the present invention. For clarity and ease of illustration, the flow diagram of FIG. 3 is described based on the assumption that there is one database 150A that presently exists in the cluster (see FIG. 1), and that the operating condition being monitored by the management module 140 is the “user load” level of the database 150A (e.g., the number of users accessing the database 150A over a given time period, namely per day). It is farther assumed that the threshold value associated with this user load condition is four hundred (400) users per day.

Referring now to FIG. 3, the management module 140 determines (at 310) if a value representative of the monitored condition (at 210 of FIG. 2) is greater than the accessed (at 220 of FIG. 2) preselected threshold value (shown as p.t.v. in FIG. 3). Thus, in the illustrated example, the management module 140 determines (at 310) if the daily number of database users exceeds the preselected threshold value of 400 users per day. If it is determined (at 310) that the value representative of the monitored operating condition exceeds the preselected threshold value, then that is an indication that at least one additional database replica 150B of the database 150A may be desired to reduce the load on the database 150A.

If it is determined that at least one additional database replica 150B is desired, the management module 140 identifies (at 320) a suitable server 120 on which the additional database replica 150B should be created. The management module 140 may identify a suitable server 120 based on one or more of a variety of factors, including available storage capacity of the servers 120(1-3), network connection speed of the servers 120(1-3), processing power of the servers 120(1-3), processing load of the servers 120(1-3), and the like. For example, a server 120 with a relatively large storage capacity, fast network connection, and high-end processor may be a more attractive candidate than another server 120 that has a relatively small storage capacity, slow network connection, and a low-end processor. The particular algorithm utilized to identify suitable servers 120(1-3) will vary from one implementation to another. It should be noted that the above-specified factors are exemplary in nature, and that, in alternative embodiments, other criterion or criteria may be utilized to identify a suitable server 120 for storing database replica(s) 150B of the database 150A.

In one embodiment, the management module 140 may identify (at 320) more than one suitable server 120(1-3). That is, more than one server 120 may satisfy the criterion or criteria and thus qualify to be acceptable candidates. In such a scenario, the management module 140 may select any one of the server acceptable candidates for storing a database replica 150B of the database 150A. In an alternative embodiment, when multiple servers 120(1-3) are identified to be acceptable candidates, the management module 140 may select more than one server 120. In such a case, if desired, the management module 140 may distribute one or more portions of the database 150A across the various qualified servers 120(1-3).

It should be appreciated that, in one embodiment, instead of identifying a suitable server 120 (at 320) to store the replicated database 150B, the management module 140 may identify one or more storage units (not shown) coupled to the network 130 (see FIG. 3) that are suited for storing the database replica 150B of the database 150A. In one embodiment, each storage unit (not shown) may have its own associated server 120.

The management module 140 creates (at 330) at least one database replica 150B of the database 150A on the server 120(1-3) that is identified to be suitable (at 320). For example, in FIG. 1, the database 150A is replicated on the server 120(2), with the database replica being referenced by numeral 150B. The database 150A can be replicated on any of the identified servers 120(1-3) using conventional methods known to those skilled in the art. Although FIG. 3 illustrates making a replica of the entire database 150A, in one embodiment, the management module 140, if desired, may create database replicas 150B of select portion(s) of the database 150A (as opposed to the entire database 150A). With the ability to replicate select portion(s) of the database 150A, the management module 140 can provide a greater granularity of control for managing databases 150A. In one embodiment, the selected portion(s) of the database 150A may each be stored on different servers 120(1-3).

As described above, the management module 140, in one embodiment, creates a database replica 150B of a database 150A on a suitable server 120 based on determining (at 310) that the monitored operating condition exceeds the preselected threshold value. However, if it is determined (at 310) that the monitored condition does not exceed the preselected threshold value, then the management module 140 determines (at 350) if it is desirable to reduce the number of existing database replicas 150B of the database 150A in view of the monitored condition (at 210 see FIG. 2). For example, a relatively low use of the database 150A (and its database replicas 150B) may indicate that the demand for the database 150A is relatively low, and that it may be advantageous to remove some undesired database replicas 150B to save network resources. For example, assuming that two (2) database replicas 150B of the database 150A are present in the cluster of FIG. 1, and that on the average only ten (10) users per day have visited the database over a span of a month, under these operating conditions, the management module 140 may determine (at 350) that it is desirable to delete at least one of the database replicas 150B of the database 150A. In one embodiment, the management module 140 may reduce the number of database replicas 150B based on comparing the monitored condition against a second preselected threshold value, where the second threshold value can be programmable by the end user or administrator.

If it is determined (at 350) that at least one of the database replicas 150B should be removed, then the management module 140 identifies (at 355) which database replica 150B to remove. The management module 140 may identify a database replica 150B to remove based on one or more of a variety of factors, including available storage capacity of the servers 120(1-3) (database replicas 150B on smaller storage units may be deleted over others), network connection speed of the servers 120(1-3) (database replicas 150B associated with servers 120(1-3) with slower-speed network connections may be deleted over those servers 120(1-3) having network connections with faster speed), processing power of the servers 120(1-3) (database replicas 150B associated with servers 120(1-3) with slower processors may be deleted over servers 120(1-3) with faster processors), processing load of the servers 120(1-3) (database replicas 150B associated with servers 120(1-3) with relatively high processing loads may be deleted over servers 120(1-3) with lower processing loads), and the like. Of course, in alternative embodiments, other factors may also be considered. In one embodiment, any combination of the aforementioned factors may be considered in identifying one or more of the database replicas 150B to delete.

Once a database replica 150B has been identified (at 355), the management module 140 removes (at 360) at least one database replica 150B from the server 120. In one embodiment, the management module 140 may remove selected portions of a database replica 150B (as opposed to the entire database replica 150B), if desired.

If the management module determines (at 350) that, based on the monitored conditions, it may not be desirable to reduce the number of database replicas 150B of the database 150A in the cluster, then, in one embodiment, no further action is taken (at block 560). Thus, in the illustrated example, if the monitored conditions indicate that the user demand is within an acceptable range for the number of existing database replicas 150B, then no further action is taken, and the number of database replicas 150B is not modified.

In one embodiment, the above-described process may be continuously repeated to monitor the operating condition(s). And if a change is detected in the monitored operating condition(s), the management module 140 takes the appropriate action based on the detected change. Thus, in accordance with one or more embodiments of the present invention, the management module 140 is capable of transparently managing the databases in the cluster of FIG. 1. As a result, the administrator's burden of manually tracking the various database replicas of the databases in the cluster can be reduced, thereby resulting in savings of time and money. One or more embodiments of the present invention may also be useful in tracking databases that are created by non-administrator users. That is, in some instances, unbeknownst to the administrator, users may create their own databases in the cluster or communications system 100. In such an instance, the management module 140 may assist individual users in controlling the number of database replicas based on the associated operating condition(s), with minimal intervention from the administrator.

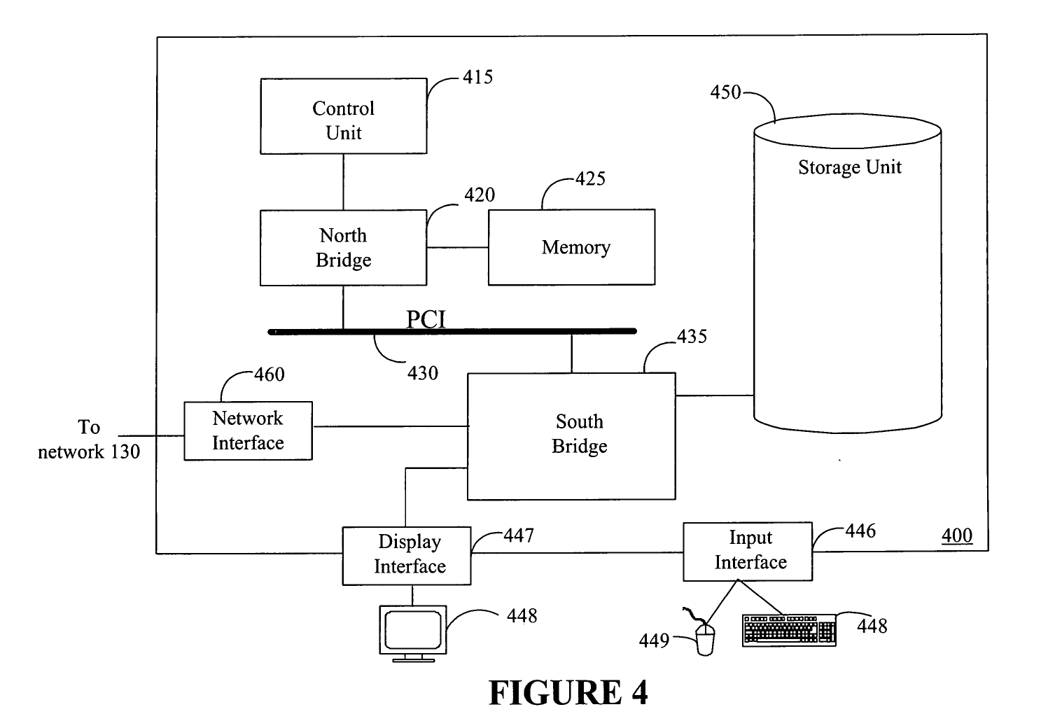

Referring now to FIG. 4, a stylized block diagram of a system 400 that may be implemented in the communications system of FIG. 1 is illustrated, in accordance with one embodiment of the present invention. That is, the system 400 may represent one embodiment of the servers 120(1-3). The system 400 comprises a control unit 415, which in one embodiment may be a processor that is capable of interfacing with a north bridge 420. The north bridge 420 provides memory management functions for a memory 425, as well as serves as a bridge to a peripheral component interconnect (PCI) bus 430. In the illustrated embodiment, the system 400 includes a south bridge 435 coupled to the PCI bus 430.

A storage unit 450 is coupled to the south bridge 435. The management module 140 may be storable in the storage unit 450, and can be executable by the control unit 415. Although not shown, it should be appreciated that in one embodiment an operating system, such as Windows®, Disk Operating System®, Unix®, OS/2®, Linux®, MAC OS®, or the like, may be stored on the storage unit 450 and executable by the control unit 415. The storage unit 450 may also include device drivers for the various hardware components of the system 400.

In the illustrated embodiment, the system 400 includes a display interface 447 that is coupled to the south bridge 435. The system 400 may display information on a display device 448 via the display interface 447. The south bridge 435 of the system 400 may include a controller (not shown) to allow a user to input information using an input device, such as a keyboard 448 and/or a mouse 449, through an input interface 446.

The south bridge 435 of the system 400, in the illustrated embodiment, is coupled to a network interface 460, which may be adapted to receive, for example, a local area network card. In an alternative embodiment, the network interface 460 may be a Universal Serial Bus interface or an interface for wireless communications. The system 400 communicates with other devices coupled to the network 130 through the network interface 460. Although not shown, associated with the network interface 460 may be a network protocol stack, with one example being a UDP/IP (User Datagram Protocol/Internet Protocol) stack. UDP is described in RFC 768, entitled “User Datagram Protocol,” dated August 1980. In one embodiment, both inbound and outbound packets may be passed through the network interface 460 and the network protocol stack.

It should be appreciated that the configuration of the system 400 of FIG. 4 is exemplary in nature and that, in other embodiments the system 400 may include fewer, additional, or different components without deviating from the spirit and scope of the present invention. For example, in an alternative embodiment, the system 400 may not include a north bridge 420 or a south bridge 435, or may include only one of the two bridges 420, 435, or may combine the functionality of the two bridges 420, 435. As another example, in one embodiment, the system 400 may include more than one control unit 415. Similarly, other configurations may be employed consistent with the spirit and scope of the present invention.

The various system layers, routines, or modules may be executable control units (such as control unit 415 (see FIG. 4)). The control unit 415 may include a microprocessor, a microcontroller, a digital signal processor, a processor card (including one or more microprocessors or controllers), or other control or computing devices. The storage devices 450 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices 450. The instructions when executed by a respective control unit 415 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
monitoring at least one operating condition associated with a database;
accessing a prestored threshold value associated with the at least one operating condition;
comparing a value representative of the monitored operating condition with the prestored threshold value; and
adjusting a number of copies of at least a portion of the database based on the comparison.

2. The method of claim 1, wherein the act of monitoring comprises monitoring a number of users accessing the database over a selected time period, and wherein the act of accessing comprises accessing the threshold value that is indicative of a number of users that can access the database over the selected time period before an adjustment is made to the number of copies of the database.

3. The method of claim 1, wherein the database is associated with a processor-based device that is communicatively coupled to a network, wherein the act of monitoring comprises monitoring at least one of resources associated with the processor-based device, process load associated with the processor-based device, traffic flow associated with the network, and frequency of failovers associated with the database.

4. The method of claim 1, wherein the act of adjusting comprises increasing the number of database copies of the database in response to determining that the prestored threshold value exceeds the representative value of the monitored operating condition.

5. The method of claim 4, wherein increasing the number of copies of the database comprises making a copy of the database, and further comprising identifying at least one of a plurality of devices on which the copy of the database is to be stored and storing the database replica on the identified device.

6. The method of claim 5, wherein the act of identifying comprises identifying the device based on at least one of an amount of available resource associated with the device, a network connection rate associated with the device, and a processing capability associated with the device.

7. The method of claim 1, wherein the act of adjusting comprises reducing the number of copies of the database in response to determining that the representative value of the monitored operating condition is less than the prestored threshold value.

8. The method of claim 7, wherein a plurality of copies of databases exists on one or more devices, further comprising identifying at least one copy of the database from the plurality of database copies to delete based on at least one of an amount of available resources associated with the device, a network connection rate associated with the device, and a processing capability associated with the device.

9. An article comprising one or more machine-readable storage media containing instructions that when executed enable a processor to:
determine at least one operating condition associated with a database;
access a prestored threshold value;
compare a value representative of the determined operating condition with the prestored threshold value; and
adjust a number of database replicas based on the comparison.

10. The article of claim 9, wherein the instructions when executed enable the processor to make at least one replica of the database in response to determining that the prestored threshold value exceeds the representative value.

11. The article of claim 10, wherein the instructions when executed enable the processor to identify at least one of a plurality of devices on which the replica of the database is to be stored and to store the database replica on the identified device.

12. The article of claim 11, wherein the instructions when executed enable the processor to identify the device based on at least one of an amount of available resource associated with the device, a network connection rate associated with the device, and a processing capability associated with the device.

13. The article of claim 9, wherein the instructions when executed enable the processor to reduce the number of replicas of the database in response to determining that the representative value is less than the prestored threshold value.

14. The article of claim 10, wherein a plurality of database replicas exists on one or more devices, wherein the instructions when executed enable the processor to identify at least one replica of the database from the plurality of database replicas to delete based on at least one of an amount of available resources associated with the device, a network connection rate associated with the device, and a processing capability associated with the device.

15. The article of claim 9, wherein the instructions when executed enable the processor to determine a number of users accessing the database over a selected time period and to access the threshold value that is indicative of a number of users that can access the database over the selected time period before an adjustment is made to the number of replicas of the database.

16. An apparatus, comprising:
a storage unit having stored therein a database; and
a control unit communicatively coupled to the storage unit, the control unit adapted to:
determine at least one operating condition associated with the database;
access a prestored threshold value;
compare a value representative of the determined operating condition with the prestored threshold value; and
adjust a number replicas of the database based on the comparison.

17. The apparatus of claim 16, wherein the control unit is adapted to make at least one replica of the database in response to determining that the prestored threshold value exceeds the representative value of the operating condition.

18. The apparatus of claim 17, wherein the control unit is adapted to identify at least one of a plurality of devices on which the replica of the database is to be stored and to store the database replica on the identified device.

19. The apparatus of claim 18, wherein the control unit is adapted to identify the device based on at least one of an amount of available resource associated with the device, a network connection rate associated with the device, and a processing capability associated with the device.

20. The apparatus of claim 16, wherein the control unit is adapted to reduce the number of replicas of the database in response to determining that the representative value is less than the prestored threshold value.

21. The apparatus of claim 16, wherein a plurality of database replicas exists on one or more devices, wherein the control unit is adapted to identify at least one replica of the database from the plurality of database replicas to delete based on at least one of an amount of available resources associated with the device, a network connection rate associated with the device, and a processing capability associated with the device.

22. The apparatus of claim 16, wherein the control unit is adapted to determine a number of users accessing the database over a selected time period and to access the threshold value that is indicative of a number of users that can access the database over the selected time period before an adjustment is made to the number of replicas of the database.

23. A system, comprising:
a first server; and
a second server communicatively coupled to the first server, the second server adapted to:
determine at least one operating condition associated with a database;
access a prestored threshold value;
compare a value representative of the determined operating condition with the prestored threshold value; and
cause a replica of the database to be created on the first server based on the comparison.

24. The system of claim 23, wherein the first server and the second server are associated with a cluster.

25. The system of claim 23, wherein the second server is further adapted to cause the database replica to be removed based on comparing a value representative of the determined operating condition with a second prestored threshold value.

26. A method, comprising:
monitoring at least one of a user load level and network traffic level associated with accessing of a database;
accessing a preselected threshold value;
comparing at least one of the user load level and network traffic level with the preselected threshold value; and
automatically adjusting a number of copies of at least a portion of the database based on the comparison.

27. The method of claim 26, further comprising dynamically adjusting the preselected threshold value based on one or more surrounding operating conditions.

28. The method of claim 26, wherein adjusting the number of copies comprises creating at least one replica of the database based on the comparison.

29. The method of claim 26, wherein adjusting the number of copies comprises deleting at least one copy of the database based on the comparison.
